(19) United States
(12) Patent Application Publication
(10) Pub. No.: US 2025/0298575 A1
(43) Pub. Date: Sep. 25, 2025

(54) HEADSET STAND WITH AUDIO MIXING

(71) Applicant: NZXT, INC., City of Industry, CA (US)

(72) Inventor: Johnny HOU, Pasadena, CA (US)

(73) Assignee: NZXT, INC., City of Industry, CA (US)

(21) Appl. No.: 18/611,846

(22) Filed: Mar. 21, 2024

(51) Int. Cl. G06F 3/16; A63F 13/54; A63F 13/87

(52) U.S. Cl. CPC G06F 3/165; A63F 13/54; A63F 13/87

(57) ABSTRACT

In one embodiment, a headset stand configured to deliver a multi-component audio signal from a computer to a headset includes a volume controller for controlling a volume level of the multi-component audio signal, and a mixer for controlling a relative level of components of the multi-component audio signal. In certain embodiments, the relative level control can be ratiometric, decreasing one component level while increasing another.

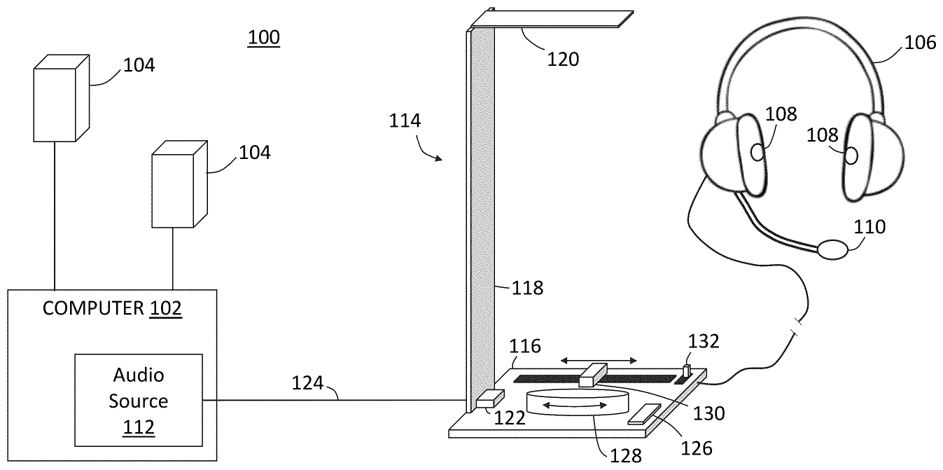

### TECHNICAL FIELD

The present disclosure relates generally to audio headsets.

### BACKGROUND

A headset is a hands-free device that typically combines a pair of headphones with a microphone, although the latter is optional. A headset is worn on the head of a user and typically covers or rests on the ears. Headsets are often used for making and receiving phone calls, gaming, or listening to music or audio. VR and AR headsets are specialized headsets that display visuals directly on the user's eyes, often paired with headphones for immersive audio. Headsets can provide immersive listening experiences, especially with features like noise cancellation and surround sound.

A gaming headset is a type of headphone that is specifically designed for use with video games. They typically have features that are important for gamers, such as noise cancellation and surround sound, which allows hearing sounds from all directions, which can help better locate enemies and other important objects in the game world.

Gaming headsets are often worn for long periods of time, so it is important that they are comfortable to wear. They typically have large ear cups and padded headbands. They may include a microphone, which allows a player to communicate with other players online.

A gaming headset stand is a device that is used to store a headset when not in use. This can help to prevent the headset from getting damaged and can also keep a desk tidy. Gaming headset stands come in a variety of styles, some of which simply provide support, while others have built-in charging docks that allow charging the headset wirelessly. Others still have LED lights that can be customized to match a gaming setup.

It is known to equip headset stands with sensors that determine when the headset is in a resting position on the stand, or is alternatively removed from the stand for wear by the user. Such a sensor, which can be a mechanical switch or the like, can also be used to activate or deactivate other functions that may for example be electronic in nature. As an example, the sensor can decouple the headset from the system audio and couple loudspeakers to the system audio when the headset is rested on the stand; and can couple the headset to the system audio and decouple the loudspeakers from the system audio when the headset is removed from the stand for wear by the user.

### OVERVIEW

Described herein is a headset stand configured to deliver a multi-component audio signal from a computer to a headset includes a volume controller for controlling a volume level of the multi-component audio signal, and a mixer for controlling a relative level of components of the multi-component audio signal.

### BRIEF DESCRIPTION OF THE DRAWINGS

The accompanying drawing figure, which is incorporated into and constitutes a part of this specification, illustrates an example embodiment and, together with the description of example embodiments, serves to explain the principles and implementations of the embodiments.

The drawing FIGURE is a schematic diagram of a gaming system in accordance with certain embodiments.

### DESCRIPTION OF EXAMPLE EMBODIMENTS

Example embodiments are described herein in the context of a headset stand with audio mixing. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The drawing figure is a schematic diagram of a gaming system 100 in accordance with certain embodiments. Gaming system 100 includes a computer 102 for running a game program that may be self-contained, or hosted at least partially on a remote server (not shown) to which the computer is connected through a cloud or other network (not shown) or a combination thereof in a known manner. A user interacts with the game program by way of a user interface, which includes a display (not shown), as well as loudspeakers 104, and a headset 106 having one or more speakers 108 and a microphone 110. An audio source 112 provides an audio signal that is selectively deliverable through the loudspeakers 104 and the speakers 108 of the headset 106. The audio signal in this example is a multi-component game audio signal that contains audio signal components such as game sounds (e.g., music, sound effects, character voices, explosions, etc.) and chat (player voices for example in a conversation during multiplayer play). In alternative embodiments, the multi-component audio signal is a multi-channel music signal with different channels carrying different music tracks that may be altogether unrelated to a game. In certain embodiments, the computer 102 may be a general PC (personal computer) or laptop computer, a specialized gaming PC or laptop computer, or it may be a a tablet, gaming console, or any such device commonly used for gaming.

Gaming system 100 includes a headset stand 114 having a base 116, a tower 118 and a rest 120. The coupling of these three components to each other is such that the placement of the headset 106 on the rest 120 is detectable by a sensor 122, for example due to the weight of the headset 106 driving down tower 118, which may be movably connected to the base 116 and normally biased upwards by appropriate means such as a spring (not shown). Sensor 122 is configured to issue a signal indicating the presence or absence of the headset 106 on the stand 114 based on the weight of the headset exerted on the rest 120. Other means for sensing the presence of the headset 106 on the stand 114, or more generally the coupling and decoupling of the headset with the stand, are also contemplated, such as photodetectors, magnetic or inductive sensors, and the like.

Headset stand 114 is operable to deliver the multi-component audio signal from computer 102 to headset 106. For this purpose, cable 124 couples audio source 112 to a control circuit 126 that controllably conveys the audio signal to the headset 106. It will be appreciated that the cable 124 can comprise more than one wire, and can carry other signals (such as from the headset stand 114 to the computer 102), as well as power, and the like.

In the instant example, the audio signal delivered to the headset 106 is a multi-component game audio signal that can contain a game sounds component and a chat component as explained above. The audio signal may be high resolution audio in any of known formats such as stereo, surround sound, in-game spatial audio in a 3D environment, and so on. The components of the audio signal—that is, the game sounds component and chat component—are selectively adjustable by the control circuit 126, through appropriate user controls such as a volume controller, for example in the form of rotatable knob 128, and a mixer for example in the form of a slider 130. For example, in a first mode in which the headset 106 is removed (decoupled) from the headset stand 114 for wear by the user, as indicated by sensor 122 to control circuit 126, volume knob 128 can be used to adjust the level of the audio volume that is output by speakers 108 of the headset, including to mute same. In certain embodiments, the audio volume adjusted in this manner can encompass all the audio components—that is, the game sounds component and the chat component, locally adjusting their levels collectively. Similarly in the first (decoupled) mode in which the headset 106 is removed from the headset stand 114 for wear by the user, slider 130 can be used to provide a mixing function, by adjusting the level of the audio components relative to one another. This relative adjustment can, in a first example, be ratiometric, whereby moving the slider 130 in one direction can increase the chat level and at the same time decrease the game sound level; while moving it in the opposite direction can decrease the chat level and at the same time increase game sound level. At the extreme ends of these two excursions of the slider 130, the game level is muted completely or the chat is muted completely. The relative adjustment can, in a second example, be non-ratiometric. That is, in a non-ratiometric relative adjustment of the audio components, moving the slider 130 in one direction can for example decrease (or increase) the chat level without affecting the game sound level; or decrease (or increase) the game sound level without affecting the chat level. In certain embodiments, both options are envisioned, and can be selectively enabled by a user-selectable switch 132 that links the slider 130 to control of either the chat level or game sound level in this manner depending on the switch position. In certain embodiments, the switch 132 can have more than two positions for selection of control other audio components depending on the application; or multiple switches can be utilized for this purpose. The relative adjustment, whether ratiometric or non-ratiometric, provides the user with for example the ability to selectively de-emphasize an audio component, such as the chat, for instance in a particularly trying and difficult stage of the game so that the player can better focus on the gameplay. Once that stage of the game has been successfully completed, the player can then re-emphasize, or mix in, the chat and resume listening to and participating in player conversation.

In certain embodiments, operation in a second (coupled) mode is also contemplated, whereby volume control and mixing as described above can be effected when the headset 106 is disposed on the stand, as sensed by the switch 122. In this second mode, however, it is the output of the loudspeakers 104 rather than the headset speakers 108 that is adjusted by the volume knob 128 and slider 130, as determined and controlled by the control circuit 126 in communication with computer 102 by way of the one or more cables 124.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A headset stand configured to deliver a multi-component audio signal from a computer to a headset, the headset stand comprising:
a volume controller for controlling a volume level of the multi-component audio signal; and
a mixer for controlling a relative level of component of the multi-component audio signal.

2. The headset stand of claim 1, further comprising a sensor for detecting the coupling and decoupling of the headset from the headset stand whereby upon decoupling, the headset stand operates in a first mode in which the volume controller and mixer adjust audio output by speakers of the headset, and upon coupling the headset stand operates in a second mode in which the volume controller and mixer adjust audio output by loudspeakers of the computer.

3. The headset stand of claim 1, wherein the volume controller is a rotatable knob.

4. The headset stand of claim 1, wherein the mixer is a slider.

5. The headset stand of claim 1, wherein the sensor is operable based on weight of the headset.

6. The headset stand of claim 1, wherein the mixer is operable to ratiometrically change a game sounds component and a chat component.

7. The headset stand of claim 1, wherein the mixer is operable to change a game sounds component only.

8. The headset stand of claim 1, wherein the mixer is operable to change a chat component only.

9. The headset stand of claim 1, wherein the volume controller is operable to control both a game sounds component and a chat component.

10. The headset stand of claim 1, wherein the computer is a gaming personal computer.

11. The headset stand of claim 1, wherein the mixer is operable to control a volume ratio of two audio components of the multi-component audio signal.
